(19) United States
(12) Patent Application Publication
(10) Pub. No.: US 2026/0352013 A1
(43) Pub. Date: Nov. 5, 2026

(54) ENERGY STORAGE DEVICE

(71) Applicant: SHENZHEN HELLO TECH ENERGY CO., LTD, Shenzhen (CN)

(72) Inventors: Wenhai LIN, Shenzhen (CN); Gaosong SHEN, Shenzhen (CN); Feiyan LUO, Shenzhen (CN)

(21) Appl. No.: 19/726,868

(22) Filed: Jun. 30, 2026

(30) Foreign Application Priority Data
Sep. 28, 2025 (CN) 202511424100.1

(51) Int. Cl. H02J 9/06; H02J 3/001; H02J 3/32; H02J 7/00; H02J 7/02

(52) U.S. Cl. CPC H02J 9/062; H02J 3/001; H02J 3/32; H02J 7/02; H02J 7/855; H02J 2207/20

(57) ABSTRACT

An energy storage device is provided. The energy storage device has a first operating mode. When the energy storage device is in the first operating mode, a first switch is turned off, a second switch, a third switch, and a fourth switch are turned on, a first alternating current-direct current conversion module operates in an inverter mode, a second alternating current-direct current conversion module operates in a rectifier mode, a first alternating current output terminal is powered by the first alternating current-direct current conversion module, and a second alternating current output terminal is powered by the alternating current input terminal.

### CROSS-REFERENCE TO RELATED APPLICATION

This application claims priority to Chinese patent application No. 202511424100.1 filed on Sep. 28, 2025, the entire contents of which are incorporated herein by reference.

### FIELD

The present disclosure belongs to the technical field of uninterruptible power supply energy storage devices, and more particularly, relates to an energy storage device.

### BACKGROUND

An Uninterruptible Power Supply (UPS) energy storage device is a system integrating energy storage technology and power electronic technology. The device is mainly configured to provide short-term backup power when an alternating current power supply fails or has an abnormal voltage, to ensure continuous operation of a critical load. A power supply mode at an output end of an existing UPS energy storage device is fixed. Most energy storage devices on the current market only have a standby power supply mode. A small number of energy storage devices are provided with both the standby power supply mode and an online power supply mode, yet only one mode may be used at an output end of such device, either the standby power supply mode or the online power supply mode.

Therefore, once a user connects a load to a wrong interface and selects an incorrect power supply mode, the load needs to be manually reconnected to a correct interface, which may result in poor user experience.

### SUMMARY

The present disclosure aims to solve at least one of the technical problems in the related art. To this end, the present disclosure provides an energy storage device. With the device, a flow direction of a current can be adjusted according to a control instruction of a user. Also, combined with control over an operating mode of an alternating current-direct current conversion module, a power supply mode corresponding to a power supply output terminal can be automatically adjusted according to selection of the user.

In a first aspect, the present disclosure provides an energy storage device. The device includes: an alternating current input terminal configured to be connected to an alternating current power supply; a first alternating current-direct current conversion module having a first end connected to the alternating current input terminal via a first branch, the first branch being provided with a first switch to control on and off of the first branch; a second alternating current-direct current conversion module having a first end connected to the alternating current input terminal via a second branch, the second branch being provided with a second switch to control on and off of the second branch; a battery module electrically connected to a second end of the first alternating current-direct current conversion module and a second end of the second alternating current-direct current conversion module, the battery module being charged and discharged via the first alternating current-direct current conversion module and the second alternating current-direct current conversion module, and the second end of the first alternating current-direct current conversion module being electrically connected to the second end of the second alternating current-direct current conversion module; a first alternating current output terminal connected to the first end of the first alternating current-direct current conversion module via a third branch, the third branch being provided with a third switch to control on and off of the third branch, and the first branch being connected to the third branch; and a second alternating current output terminal connected to the first end of the second alternating current-direct current conversion module via a fourth branch, the fourth branch being provided with a fourth switch to control on and off of the fourth branch, and the second branch being connected to the fourth branch. The energy storage device has a first operating mode. When the energy storage device is in the first operating mode, the first switch is turned off, the second switch, the third switch, and the fourth switch are turned on, the first alternating current-direct current conversion module operates in an inverter mode, the second alternating current-direct current conversion module operates in a rectifier mode, the first alternating current output terminal is powered by the first alternating current-direct current conversion module, and the second alternating current output terminal is powered by the alternating current input terminal. The energy storage device further has a second operating mode. When the energy storage device is in the second operating mode, the second switch is turned off, the first switch, the third switch, and the fourth switch are turned on, the first alternating current-direct current conversion module operates in the rectifier mode, the second alternating current-direct current conversion module operates in the inverter mode, the first alternating current output terminal is powered by the alternating current input terminal, and the second alternating current output terminal is powered by the second alternating current-direct current conversion module.

In some embodiments, the third branch is connected to the fourth branch via a fifth branch, the fifth branch being provided with a fifth switch to control on and off of the fifth branch. The energy storage device further has a third operating mode. When the energy storage device is in the third operating mode, the first switch, the third switch, and the fifth switch are turned on, the second switch and the fourth switch are turned off, the first alternating current-direct current conversion module operates in the rectifier mode, the second alternating current-direct current conversion module stops operating, and the first alternating current output terminal and the second alternating current output terminal are powered by the alternating current input terminal. Alternatively, when the energy storage device is in the third operating mode, the second switch, the fourth switch, and the fifth switch are turned on, the first switch and the third switch are turned off, the second alternating current-direct current conversion module operates in the rectifier mode, and the first alternating current-direct current conversion module stops operating, and the first alternating current output terminal and the second alternating current output terminal are powered by the alternating current input terminal.

In some embodiments, the third branch is connected to the fourth branch via a fifth branch, the fifth branch being provided with a fifth switch to control on and off of the fifth branch. The energy storage device further has a fourth operating mode. When the energy storage device is in the fourth operating mode, the first switch, the fourth switch, and the fifth switch are turned on, the second switch and the third switch are turned off, the first alternating current-direct current conversion module operates in the rectifier mode, the second alternating current-direct current conversion module operates in the inverter mode, and the first alternating current output terminal and the second alternating current output terminal are powered by the second alternating current-direct current conversion module. Alternatively, when the energy storage device is in the fourth operating mode, the second switch, the third switch, and the fifth switch are turned on, the first switch and the fourth switch are turned off, the second alternating current-direct current conversion module operates in the rectifier mode, the first alternating current-direct current conversion module operates in the inverter mode, and the first alternating current output terminal and the second alternating current output terminal are powered by the first alternating current-direct current conversion module.

In some embodiments, the energy storage device further includes a sixth branch. The first branch and the second branch are connected to the alternating current input terminal via the sixth branch, the sixth branch being provided with a sixth switch to control on and off of the sixth branch.

In some embodiments, the energy storage device further includes a controller configured to determine an adjustment scheme for one or more switches and one or more alternating current-direct current conversion modules based on a current operating mode of the energy storage device and a received control instruction and configured to control the one or more switches and the one or more alternating current-direct current conversion modules according to the adjustment scheme, to adjust power supply sources of the first alternating current output terminal and the second alternating current output terminal. The power supply sources include the one or more alternating current-direct current conversion modules and the alternating current input terminal. The one or more alternating current-direct current conversion modules include one or more of the first alternating current-direct current conversion module and the second alternating current-direct current conversion module. The one or more switches include one or more of the first switch, the second switch, the third switch, and the fourth switch.

In some embodiments, when a target operating mode corresponding to the control instruction comprises a plurality of target states of the one mor more switches, the adjustment scheme is a scheme requiring a minimum number of switches to be adjusted to switch an operating mode of the energy storage device to the target operating mode.

In some embodiments, when an alternating current output terminal is powered by an alternating current-direct current conversion module, a power supply mode of the alternating current output terminal is an online power supply mode. When the alternating current output terminal is powered by the alternating current input terminal, the power supply mode of the alternating current output terminal is a backup power supply mode. The control instruction includes a target operating mode of the energy storage device, or includes a target power supply mode of the first alternating current output terminal and a target power supply mode of the second alternating current output terminal. The controller is configured to determine the target operating mode of the energy storage device based on the control instruction, and determine the adjustment scheme for the one mor more switches and the one or more alternating current-direct current conversion modules based on the current operating mode and the target operating mode of the energy storage device.

In some embodiments, the controller is configured to, after the control instruction is received and operating modes of the first alternating current output terminal and the second alternating current output terminal are adjusted to a target operating mode corresponding to the control instruction, control operating modes of the one or more alternating current-direct current conversion modules based on the target operating mode and a voltage input state of the alternating current input terminal, to supply power to an electrical device.

In some embodiments, each alternating current-direct current conversion module includes an alternating current-direct current converter and a direct current-direct current converter. The direct current-direct current converter is disposed between the alternating current-direct current converter and the battery module. An operating mode of the alternating current-direct current conversion module is defined as an operating mode of the alternating current-direct current converter. The alternating current-direct current conversion module includes the first alternating current-direct current conversion module and the second alternating current-direct current conversion module.

In some embodiments, the third branch is connected to the fourth branch via a fifth branch, the fifth branch being provided with a fifth switch to control on and off of the fifth branch. The first branch and the second branch are connected to the alternating current input terminal via a sixth branch. The first branch, the second branch, the third branch, the fourth branch, the fifth branch, and the sixth branch are live wires. The energy storage device further includes a seventh branch, an eighth branch, a ninth branch, a tenth branch, and an eleventh branch that are neutral wires. Two ends of the seventh branch are respectively connected to the alternating current input terminal and the first alternating current output terminal. The eighth branch is configured to be connected to the seventh branch and the first end of the first alternating current-direct current conversion module. The ninth branch is configured to be connected to the second end of the first alternating current-direct current conversion module, the second end of the second alternating current-direct current conversion module, and the battery module. The tenth branch is configured to be connected to the first end of the second alternating current-direct current conversion module and the seventh branch. The eleventh branch is configured to be connected to the seventh branch and the second alternating current output terminal.

In the energy storage device according to the embodiments of the present disclosure, a plurality of switches and alternating current-direct current conversion modules are disposed between the alternating current input terminal and the alternating current output terminal of the energy storage device. By controlling each switch and each alternating current-direct current conversion module, power supply sources of the first alternating current output terminal and the second alternating current output terminal can be controlled, so that the power supply sources of the first alternating current output terminal and the second alternating current output terminal can be the corresponding alternating current-direct current conversion modules or the corresponding alternating current input terminals. Therefore, power supply modes of the first alternating current output terminal and the second alternating current output terminal can be adjusted. In this way, the energy storage device can automatically control each switch and each alternating current-direct current conversion module according to a need of a user to automatically adjust the power supply modes of the first alternating current output terminal and the second alternating current output terminal, enabling the power supply modes of the first alternating current output terminal and the second alternating current output terminal to match power supply modes of the respective connected electrical devices. There is no need for the user to manually re-plug the electrical device into a correct alternating current output terminal, thereby saving an operation of the user and improving user experience.

Additional aspects and advantages of the embodiments of the present disclosure will be provided at least in part in the following description, or will become apparent at least in part from the following description, or can be learned from practicing of the embodiments of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a schematic diagram of an application scenario of an energy storage device according to some embodiments of the present disclosure.

FIG. 2 is a schematic diagram of a circuit of an energy storage device according to some embodiments of the present disclosure.

FIG. 3 is a schematic diagram of a circuit of an energy storage device according to some embodiments of the present disclosure.

FIG. 4 is a schematic diagram of a circuit of an energy storage device according to some embodiments of the present disclosure.

FIG. 5 is a schematic diagram of a circuit of an energy storage device according to some embodiments of the present disclosure.

FIG. 6 is a schematic diagram of a circuit of an energy storage device according to some embodiments of the present disclosure.

FIG. 7 is a schematic diagram of a circuit of an energy storage device according to some embodiments of the present disclosure.

FIG. 8 is a schematic diagram of a circuit of an energy storage device according to some embodiments of the present disclosure.

FIG. 9 is a schematic diagram of circuit state switching of an energy storage device according to some embodiments of the present disclosure.

### DESCRIPTION OF MAIN REFERENCE NUMERALS

energy storage device 100; alternating current power supply 200; electrical device 300;
alternating current input terminal 11; first alternating current output terminal 121; second alternating current output terminal 122; battery module 20; first alternating current-direct current conversion module 31; second alternating current-direct current conversion module 32; alternating current-direct current converter 33; direct current-direct current converter 34;
controller 40;
first branch L1; second branch L2; third branch L3; fourth branch L4; fifth branch L5; sixth branch L6; seventh branch N1; eighth branch N2; ninth branch N3; tenth branch N4; eleventh branch N5;
first switch K1; second switch K2; third switch K3; fourth switch K4; fifth switch K5; sixth switch K6.

### DETAILED DESCRIPTION

Embodiments of the present disclosure will be described in detail below as illustrated in examples thereof as illustrated in the accompanying drawings, throughout which same or similar elements, or elements having same or similar functions, are denoted by same or similar reference numerals. The embodiments described below as illustrated in the drawings are illustrative, and are only intended to explain, rather than limiting, the present disclosure.

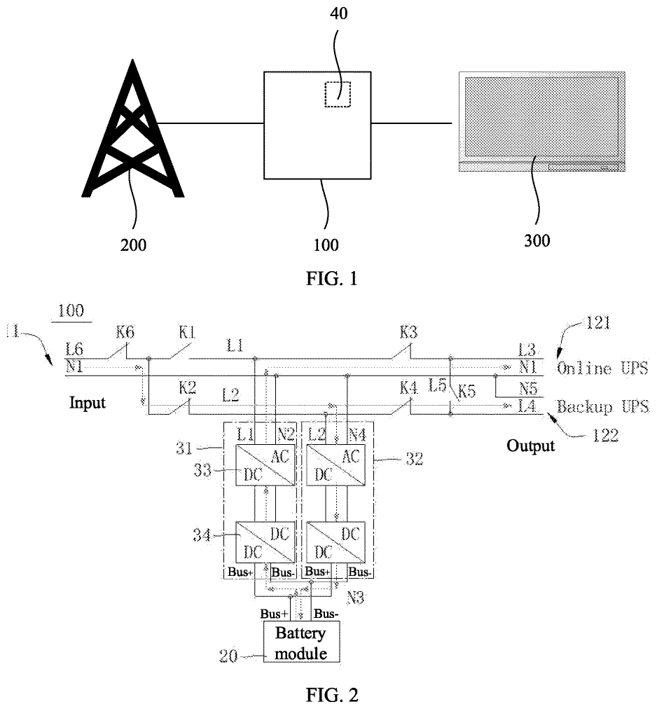

FIG. 1 is a schematic diagram of an application scenario of an energy storage device 100 according to an embodiment of the present disclosure. As illustrated in FIG. 1 and FIG. 2, the application scenario according to the present disclosure involves an energy storage device 100, an alternating current power supply 200, and an electrical device 300. The alternating current power supply 200 is an apparatus that provides an alternating current (AC). For example, the alternating current power supply 200 may be a power grid. The electrical device 300 refers to a terminal device that performs a function by consuming electric energy, and operation thereof depends on power supply from the alternating current power supply 200 or a backup power source (such as an UPS energy storage device 100).

The energy storage device 100 is an Uninterruptible Power Supply (UPS) energy storage device 100, which is a system integrating energy storage technology and power electronic technology. An input terminal of the energy storage device 100 is connected to the alternating current power supply 200. An output terminal of the energy storage device 100 is connected to the electrical device 300. The energy storage device 100 is mainly configured to provide short-term backup power when the alternating current power supply 200 fails or has an abnormal voltage, to ensure continuous operation of a critical load.

The energy storage device 100 is provided with a backup power supply mode, an online power supply mode, and other modes. Most energy storage devices 100 on the current market only have the backup power supply mode. A small number of energy storage devices 100 have both the backup power supply mode and the online power supply mode, yet an output terminal of such energy storage devices 100 can only operate in one mode, either the backup power supply mode or the online power supply mode.

The energy storage device 100 includes an alternating current-direct current conversion module and a battery module 20. The alternating current-direct current conversion module has a first end connected to an alternating current input terminal 11 and an alternating current output terminal of the energy storage device 100, and a second end connected to the battery module 20.

The battery module 20 is an energy storage apparatus that converts chemical energy directly into electric energy through electrochemical reaction, and can provide continuous or pulsed direct current (DC) power to an external circuit.

The alternating current-direct current conversion module is a key component in a power electronic system, which is responsible for converting the electric energy from one form (alternating current or direct current) to another, or adjusting a voltage/current level to meet needs of different loads. In a UPS (uninterruptible power supply) system, a common alternating current-direct current conversion module includes an alternating current-direct current converter 33 (AC/DC converter) and a direct current-direct current converter 34 (DC/DC converter). The AC/DC converter is a power electronic apparatus that converts the alternating current (AC) into a direct current (DC). The DC/DC converter is configured to adjust a direct current voltage level. In the UPS energy storage device 100, the DC/DC converter is mainly configured for voltage matching of the battery module 20, multi-level power supply management, or distributed power supply. In some embodiments, the direct current-direct current converter 34 is disposed between the alternating current-direct current converter 33 and the battery module 20.

In the backup power supply mode, if the alternating current power supply 200 supplies power, the energy storage device 100 may directly output electric energy input from the alternating current power supply 200 to the electrical device 300, and input the electric energy delivered by the alternating current power supply 200 to the alternating current-direct current conversion module and the battery module 20 to charge the battery module 20. In this case, the alternating current-direct current conversion module is in a rectifier mode. If the alternating current power supply 200 fails, the battery module 20 of the energy storage device 100 supplies power to the electrical device 300. In this case, the alternating current-direct current conversion module is in an inverter mode, and the electric energy of the battery module 20 flows to the electrical device 300 via the alternating current-direct current conversion module. Switching of an operating mode of the alternating current-direct current conversion module requires a certain time, for example, 20 ms.

In the online power supply mode, if the alternating current power supply 200 supplies power, a current may undergo rectification and inversion by the alternating current-direct current conversion module and the battery module 20, and then flow to the electrical device 300. In this case, the alternating current-direct current conversion module is in the inverter mode. If the alternating current power supply 200 fails, the battery module 20 of the energy storage device 100 supplies power to the electrical device 300. In this case, the alternating current-direct current conversion module is in the inverter mode, and the electric energy of the battery module 20 flows to the electrical device 300 via the alternating current-direct current conversion module. Therefore, if the alternating current power supply 200 fails, the energy storage device 100 in the backup power supply mode requires certain switching time to supply power to the electrical device 300, while the energy storage device 100 in the online power supply mode requires no switching time.

Therefore, for some electrical devices 300 requiring high power supply continuity, such as a medical device, the electrical devices 300 need to use the online power supply mode. Since the online power supply mode continuously converts the current, while the backup power supply mode does not need to convert the current when the alternating current power supply 200 supplies power, the online power supply mode has lower efficiency than the backup power supply mode. The term “efficiency” herein refers to a ratio of output electric energy available to the electrical devices 300 to input electric energy (from the alternating current power supply 200 or the battery module 20) of the UPS system. For some electrical devices 300 with a low requirement for power supply continuity, such as a home computer, the electrical devices 300 may use the backup power supply mode to improve the efficiency and reduce an electric energy loss.

The energy storage device 100 includes a controller 40. The controller 40 may be configured to implement control and management of other components of the energy storage device 100, such as each switch and each alternating current-direct current conversion module of the energy storage device 100. The controller 40 may be connected to a terminal, to receive a control instruction from the terminal and perform control over other components of the energy storage device 100 according to the control instruction. For example, the control instruction may include instructions for starting power supply and ending power supply.

The terminal may directly establish a communication connection with the controller 40, or be connected to the cloud via a network, and then indirectly achieve a wireless connection with the energy storage device 100 connected to the cloud by the cloud. The cloud and the energy storage device 100 may communicate with each other via a Message Queuing Telemetry Transport (MQTT) protocol. MQTT is a lightweight communication protocol based on a publish/subscribe model, which is particularly suitable for use by a resource-constrained device and under network conditions with low bandwidth, high latency, or unreliability.

In some embodiments, in the case where at least one of the terminal or the energy storage device 100 is disconnected from the network, the terminal directly establishes the communication connection with the energy storage device 100 via wireless communication or wired communication. The wireless connection includes bluetooth connection communication (Bluetooth), wireless local area network (WiFi) communication, near-field communication protocol (Zigbee) communication, or infrared communication.

The bluetooth connection communication (Bluetooth) and the near-field communication protocol (Zigbee) require a communication connection to be established first before communication is performed. The infrared communication only requires the terminal to be provided with an infrared transmitter and the energy storage device 100 to be provided with an infrared receiver. The terminal emits modulated infrared light, and the energy storage device 100 demodulates the infrared light to obtain a control instruction sent by the terminal, thereby realizing operation control of the energy storage device 100 without establishing the communication connection.

The terminal may include, but is not limited to: a smart phone (such as an Android phone, an iOS phone, etc.), a tablet computer, a laptop computer, a desktop computer, a smart speaker, a smart watch, a portable personal computer, a Mobile Internet Device (MID), a smart voice interaction device, a smart home appliance, a vehicle-mounted terminal, an aircraft, a wearable device, etc., which is not limited in the embodiments of the present disclosure.

Based on the introduction of the above related scenarios, an embodiment of the present disclosure provides an energy storage device 100, which is described in detail below.

As illustrated in FIG. 1 and FIG. 2, the energy storage device 100 according to the embodiment of the present disclosure includes an alternating current input terminal 11, a first alternating current-direct current conversion module 31, a second alternating current-direct current conversion module 32, a battery module 20, a first alternating current output terminal 121, and a second alternating current output terminal 122. The alternating current input terminal 11 is configured to be connected to an alternating current power supply 200. The first alternating current-direct current conversion module 31 has a first end connected to the alternating current input terminal 11 via a first branch L1. The first branch L1 is provided with a first switch K1 to control on and off of the first branch L1. The second alternating current-direct current conversion module 32 has a first end connected to the alternating current input terminal 11 via a second branch L2. The second branch L2 is provided with a second switch K2 to control on and off of the second branch L2. The battery module 20 is electrically connected to a second end of the first alternating current-direct current conversion module 31 and a second end of the second alternating current-direct current conversion module 32. In addition, the battery module 20 may be charged and discharged via the first alternating current-direct current conversion module 31 and the second alternating current-direct current conversion module 32. The second end of the first alternating current-direct current conversion module 31 is electrically connected to the second end of the second alternating current-direct current conversion module 32. The first alternating current output terminal 121 is connected to the first end of the first alternating current-direct current conversion module 31 via a third branch L3. The third branch L3 is provided with a third switch K3 to control on and off of the third branch L3. The first branch L1 is connected to the third branch L3. The second alternating current output terminal 122 is connected to the first end of the second alternating current-direct current conversion module 32 via a fourth branch L4. The fourth branch L4 is provided with a fourth switch K4 to control on and off of the fourth branch L4. The second branch L2 is connected to the fourth branch L4.

The energy storage device 100 has a first operating mode. When the energy storage device 100 is in the first operating mode, the first switch K1 is turned off, the second switch K2, the third switch K3, and the fourth switch K4 are turned on, the first alternating current-direct current conversion module 31 operates in an inverter mode, the second alternating current-direct current conversion module 32 operates in a rectifier mode, the first alternating current output terminal 121 is powered by the first alternating current-direct current conversion module 31, and the second alternating current output terminal 122 is powered by the alternating current input terminal 11.

The energy storage device 100 further has a second operating mode. When the energy storage device 100 is in the second operating mode, the second switch K2 is turned off, the first switch K1, the third switch K3, and the fourth switch K4 are turned on, the first alternating current-direct current conversion module 31 operates in the rectifier mode, the second alternating current-direct current conversion module 32 operates in the inverter mode, the first alternating current output terminal 121 is powered by the alternating current input terminal 11, and the second alternating current output terminal 122 is powered by the second alternating current-direct current conversion module 32.

In an exemplary embodiment of the present disclosure, the alternating current input terminal 11 is connected to the alternating current power supply 200 to obtain electric energy from the alternating current power supply 200. The alternating current output terminal includes the first alternating current output terminal 121 and the second alternating current output terminal 122. Both the first alternating current output terminal 121 and the second alternating current output terminal 122 are connected to the electrical device 300. A plurality of switches and a plurality of alternating current-direct current conversion modules are provided between the alternating current input terminal 11, the first alternating current output terminal 121, and the second alternating current output terminal 122. An operating mode of the energy storage device 100 may be controlled by controlling a state of each switch and each alternating current-direct current conversion module.

The switches are configured to control on and off of a circuit. For example, the switches may be relays. The first end of the first alternating current-direct current conversion module 31 is connected to the alternating current input terminal 11 via the first branch L1. The first branch L1 is provided with the first switch K1 to control on and off of the first branch L1. The first end of the second alternating current-direct current conversion module 32 is connected to the alternating current input terminal 11 via the second branch L2. The second branch L2 is provided with the second switch K2 to control on and off of the second branch L2. The battery module 20 is electrically connected to the second end of the first alternating current-direct current conversion module 31 and the second end of the second alternating current-direct current conversion module 32. In addition, the battery module 20 may be charged and discharged via the first alternating current-direct current conversion module 31 and the second alternating current-direct current conversion module 32. The second end of the first alternating current-direct current conversion module 31 is electrically connected to the second end of the second alternating current-direct current conversion module 32. The first alternating current output terminal 121 is connected to the first end of the first alternating current-direct current conversion module 31 via the third branch L3. The third branch L3 is provided with the third switch K3 to control on and off of the third branch L3. The first branch L1 is connected to the third branch L3. The second alternating current output terminal 122 is connected to the first end of the second alternating current-direct current conversion module 32 via the fourth branch L4. The fourth branch L4 is provided with the fourth switch K4 to control on and off of the fourth branch L4. The second branch L2 is connected to the fourth branch L4.

The alternating current-direct current conversion module includes the first alternating current-direct current conversion module 31 and the second alternating current-direct current conversion module 32. The alternating current-direct current conversion module operates in the rectifier mode and the inverter mode. In an exemplary embodiment of the present disclosure, the AC/DC conversion module operates in the rectifier mode and the inverter mode. When in the rectifier mode, the AC/DC conversion module serves as a rectifier and a charger, whose main function is to charge the battery module 20. When in the inverter mode, the AC/DC conversion module stops a rectifying function and only acts as a DC/DC boost module or a DC/DC isolation module (for some topologies), to assist an inverter of the energy storage device 100 to draw electric energy from the battery module 20 and keep a direct current bus voltage of the energy storage device 100 stable.

In some embodiments, each alternating current-direct current conversion module includes an alternating current-direct current converter 33 and a direct current-direct current converter 34. The direct current-direct current converter 34 is disposed between the alternating current-direct current converter 33 and the battery module 20. That is, each of the first alternating current-direct current conversion module 31 and the second alternating current-direct current conversion module 32 has a corresponding alternating current-direct current converter 33 and a corresponding direct current-direct current converter 34. An operating mode of the alternating current-direct current conversion module is defined as the operating mode of the alternating current-direct current converter 33. That is, the operating mode of the alternating current-direct current conversion module represents the operating mode of the alternating current-direct current converter 33. For example, if the first alternating current-direct current conversion module 31 operates in the rectifier mode, it means that the alternating current-direct current converter 33 of the first alternating current-direct current conversion module 31 operates in the rectifier mode.

The operating mode of the energy storage device 100 corresponds to a power supply mode of the alternating current output terminal. The alternating current output terminal has the backup power supply mode and the online power supply mode. In different operating modes, combinations of power supply modes corresponding to the first alternating current output terminal 121 and the second alternating current output terminal 122 are different.

The energy storage device 100 has the first operating mode. When the energy storage device 100 is in the first operating mode, the first switch K1 is turned off, the second switch K2, the third switch K3, and the fourth switch K4 are turned on, the first alternating current-direct current conversion module 31 operates in the inverter mode, the second alternating current-direct current conversion module 32 operates in the rectifier mode, the first alternating current output terminal 121 is powered by the first alternating current-direct current conversion module 31, and the second alternating current output terminal 122 is powered by the alternating current input terminal 11.

In an exemplary embodiment of the present disclosure, when the alternating current power supply 200 supplies power, the electric energy of the alternating current power supply 200 may pass through the second switch K2 and the second branch L2. A current through the second branch L2 may directly flow to the second alternating current output terminal 122 via the fourth switch K4 and the fourth branch L4. The current through the second branch L2 may also enter the second alternating current-direct current conversion module 32, and sequentially flow through the battery module 20 and the first alternating current-direct current conversion module 31 to charge the battery module 20. After flowing out of the first alternating current-direct current conversion module 31, the current flows to the first alternating current output terminal 121 via the third switch K3 and the third branch L3. In this case, the second alternating current-direct current conversion module 32 operates in the rectifier mode, and the first alternating current-direct current conversion module 31 operates in the inverter mode. A specific current flow direction is shown in FIG. 2. Gray arrows in all circuit diagrams of the present disclosure indicate a current flow direction. It can be seen that in this case, the first alternating current output terminal 121 is powered by the first alternating current-direct current conversion module 31, and a power supply mode of the first alternating current output terminal 121 is the online power supply mode. The second alternating current output terminal 122 is powered by the alternating current input terminal 11, and a power supply mode of the second alternating current output terminal 122 is the backup power supply mode.

When the alternating current power supply 200 is disconnected, the first alternating current-direct current conversion module 31 operates in the inverter mode, and the second alternating current-direct current conversion module 32 operates in the inverter mode. The electric energy of the battery module 20 may sequentially flow through the first alternating current-direct current conversion module 31, the third switch K3, and the third branch L3 until reaching the first alternating current output terminal 121. The electric energy of the battery module 20 may sequentially flow through the second alternating current-direct current conversion module 32, the fourth switch K4, and the fourth branch L4 until reaching the second alternating current output terminal 122.

The energy storage device 100 further has the second operating mode. When the energy storage device 100 is in the second operating mode, the second switch K2 is turned off, the first switch K1, the third switch K3, and the fourth switch K4 are turned on, the first alternating current-direct current conversion module 31 operates in the rectifier mode, the second alternating current-direct current conversion module 32 operates in the inverter mode, the first alternating current output terminal 121 is powered by the alternating current input terminal 11, and the second alternating current output terminal 122 is powered by the second alternating current-direct current conversion module 32.

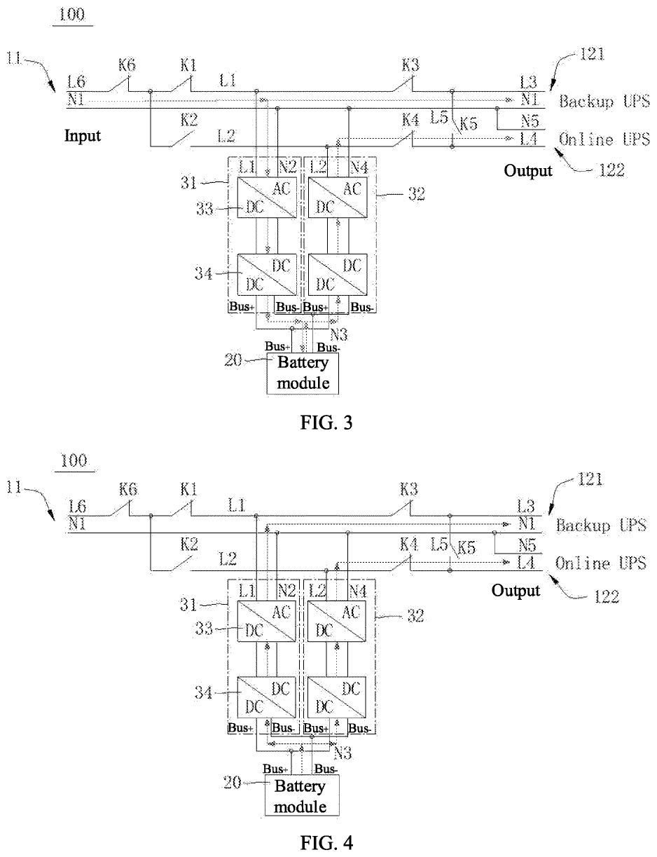

In an exemplary embodiment of the present disclosure, when the alternating current power supply 200 supplies power, the electric energy of the alternating current power supply 200 may pass through the first switch K1 and the first branch L1. A current through the first branch L1 is divided into two paths. One path of current directly flows through the third switch K3 and the third branch L3 to the first alternating current output terminal 121. Another path of current enters the first alternating current-direct current conversion module 31, and sequentially flows through the battery module 20 and the second alternating current-direct current conversion module 32 to charge the battery module 20. After flowing out of the second alternating current-direct current conversion module 32, the current flows to the second alternating current output terminal 122 via the fourth switch K4 and the fourth branch L4. In this case, the first alternating current-direct current conversion module 31 operates in the rectifier mode, and the second alternating current-direct current conversion module 32 operates in the inverter mode. A specific current flow direction is shown in FIG. 3. It can be seen that in this case, the second alternating current output terminal 122 is powered by the second alternating current-direct current conversion module 32, and the power supply mode of the second alternating current output terminal 122 is the online power supply mode. The first alternating current output terminal 121 is powered by the alternating current input terminal 11, and the power supply mode of the first alternating current output terminal 121 is the backup power supply mode.

When the alternating current power supply 200 is disconnected, the first alternating current-direct current conversion module 31 operates in the inverter mode, and the second alternating current-direct current conversion module 32 operates in the inverter mode. The electric energy of the battery module 20 may sequentially flow through the first alternating current-direct current conversion module 31, the third switch K3, and the third branch L3 until reaching the first alternating current output terminal 121. The electric energy of the battery module 20 may sequentially flow through the second alternating current-direct current conversion module 32, the fourth switch K4, and the fourth branch L4 until reaching the second alternating current output terminal 122. The specific current flow direction is shown in FIG. 4.

As can be seen, by combining the first operating mode and the second operating mode, the power supply modes of the first alternating current output terminal 121 and the second alternating current output terminal 122 can be changed. In the first operating mode, the power supply mode of the first alternating current output terminal 121 is the online power supply mode. In the second operating mode, the power supply mode of the first alternating current output terminal 121 is the backup power supply mode. In the first operating mode, the power supply mode of the second alternating current output terminal 122 is the backup power supply mode. In the second operating mode, the power supply mode of the second alternating current output terminal 122 is the online power supply mode. Therefore, the power supply modes of the first alternating current output terminal 121 and the second alternating current output terminal 122 can be adjusted according to a need of the user, to ensure that the electrical device 300 can match a power supply mode of the connected alternating current output terminal.

In summary, the plurality of switches and alternating current-direct current conversion modules are disposed between the alternating current input terminal 11 and the alternating current output terminal of the energy storage device 100. By controlling each switch and each alternating current-direct current conversion module, power supply sources of the first alternating current output terminal 121 and the second alternating current output terminal 122 can each be corresponding alternating current-direct current conversion module or the alternating current input terminal 11. Therefore, the power supply modes of the first alternating current output terminal 121 and the second alternating current output terminal 122 can be adjusted. In this way, the energy storage device 100 can automatically control each switch and each alternating current-direct current conversion module according to the need of the user to automatically adjust the power supply modes of the first alternating current output terminal 121 and the second alternating current output terminal 122, enabling the power supply modes of the first alternating current output terminal 121 and the second alternating current output terminal 122 to match power supply modes of the respective connected electrical devices 300. There is no need for the user to manually re-plug the electrical device 300 into a correct alternating current output terminal, thereby minimizing operations of the user and improving user experience.

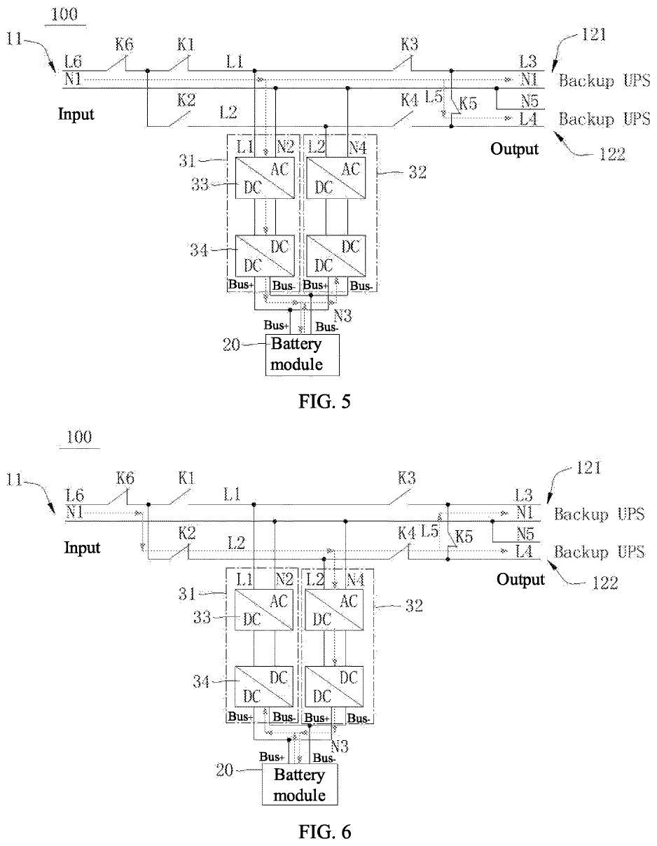

In some embodiments, as illustrated in FIG. 1, FIG. 5, and FIG. 6, when the power supply mode of the first alternating current output terminal 121 is the backup power supply mode, and the power supply mode of the second alternating current output terminal 122 is the backup power supply mode, the energy storage device 100 operates in a third operating mode. When the energy storage device 100 is in the third operating mode, the switches and alternating current-direct current conversion modules have two states.

In this case, the third branch L3 is connected to the fourth branch L4 via a fifth branch L5. The fifth branch L5 is provided with a fifth switch K5 to control on and off of the fifth branch L5.

As illustrated in FIG. 5, in a first state: the first switch K1, the third switch K3, and the fifth switch K5 are turned on, the second switch K2 and the fourth switch K4 are turned off, the first alternating current-direct current conversion module 31 operates in the rectifier mode, the second alternating current-direct current conversion module 32 stops operating, and the first alternating current output terminal 121 and the second alternating current output terminal 122 are powered by the alternating current input terminal 11.

In an exemplary embodiment of the present disclosure, when the alternating current power supply 200 supplies power, the electric energy of the alternating current power supply 200 may flow through the first switch K1 and the first branch L1. The current through the first branch L1 is divided into two paths. One path of current directly flows through the third switch K3 and the third branch L3. In this case, this path of current is further divided into two sub-paths: one sub-path of current directly flows along the third branch L3 to the first alternating current output terminal 121, and another sub-path of current flows through the fifth switch K5 and the fifth branch L5 to the second alternating current output terminal 122. Another path of current flowing through the first branch L1 enters the first alternating current-direct current conversion module 31 and then flows into the battery module 20 to charge the battery module 20. In this case, the first alternating current-direct current conversion module 31 operates in the rectifier mode, and there is no need to use the second alternating current-direct current conversion module 32. Therefore, the second alternating current-direct current conversion module 32 stops operating. The specific current flow direction is shown in FIG. 5. As can be seen, in this case, the first alternating current output terminal 121 and the second alternating current output terminal 122 are powered by the alternating current input terminal 11. The power supply modes of the two alternating current output terminals are the backup power supply mode.

When the alternating current power supply 200 is disconnected, the first alternating current-direct current conversion module 31 operates in the inverter mode, and the second alternating current-direct current conversion module 32 stops operating. The electric energy of the battery module 20 may sequentially flow through the first alternating current-direct current conversion module 31, the third switch K3, and the third branch L3. Of the current flowing out of the third branch L3, one part of current directly flows to the first alternating current output terminal 121, and another part of current flows through the fifth switch K5 and the fifth branch L5 to the second alternating current output terminal 122.

As illustrated in FIG. 6, in a second state: the second switch K2, the fourth switch K4, and the fifth switch K5 are turned on, the first switch K1 and the third switch K3 are turned off, the second alternating current-direct current conversion module 32 operates in the rectifier mode, the first alternating current-direct current conversion module 31 stops operating, and the first alternating current output terminal 121 and the second alternating current output terminal 122 are powered by the alternating current input terminal 11.

In an exemplary embodiment of the present disclosure, when the alternating current power supply 200 supplies power, the electric energy of the alternating current power supply 200 may directly flow to the second alternating current output terminal 122 via the second switch K2, the second branch L2, the fourth switch K4, and the fourth branch L4. The electric energy of the alternating current power supply 200 may also flow to the first alternating current output terminal 121 via the fourth switch K4, the fourth branch L4, the fifth switch K5, and the fifth branch L5. Also, a current flowing into the second branch L2 may also pass through the second alternating current-direct current conversion module 32 and then flow into the battery module 20 to charge the battery module 20. In this case, the second alternating current-direct current conversion module 32 operates in the rectifier mode, and there is no need to use the first alternating current-direct current conversion module 31. Therefore, the first alternating current-direct current conversion module 31 stops operating. The specific current flow direction is shown in FIG. 6. As can be seen, in this case, the first alternating current output terminal 121 and the second alternating current output terminal 122 are powered by the alternating current input terminal 11. The power supply modes of the two alternating current output terminals are the backup power supply mode.

When the alternating current power supply 200 is disconnected, the second alternating current-direct current conversion module 32 operates in the inverter mode, and the first alternating current-direct current conversion module 31 stops operating. The electric energy of the battery module 20 may sequentially flow through the second alternating current-direct current conversion module 32, the fourth switch K4, and the fourth branch L4. Of the current flowing out of the fourth switch K4, one part of current directly flows to the second alternating current output terminal 122, and another part of current flows through the fifth switch K5 and the fifth branch L5 to the first alternating current output terminal 121.

Therefore, the above two states enable the power supply mode corresponding to the first alternating current output terminal 121 to be the backup power supply mode, and the power supply mode corresponding to the second alternating current output terminal 122 to be the backup power supply mode.

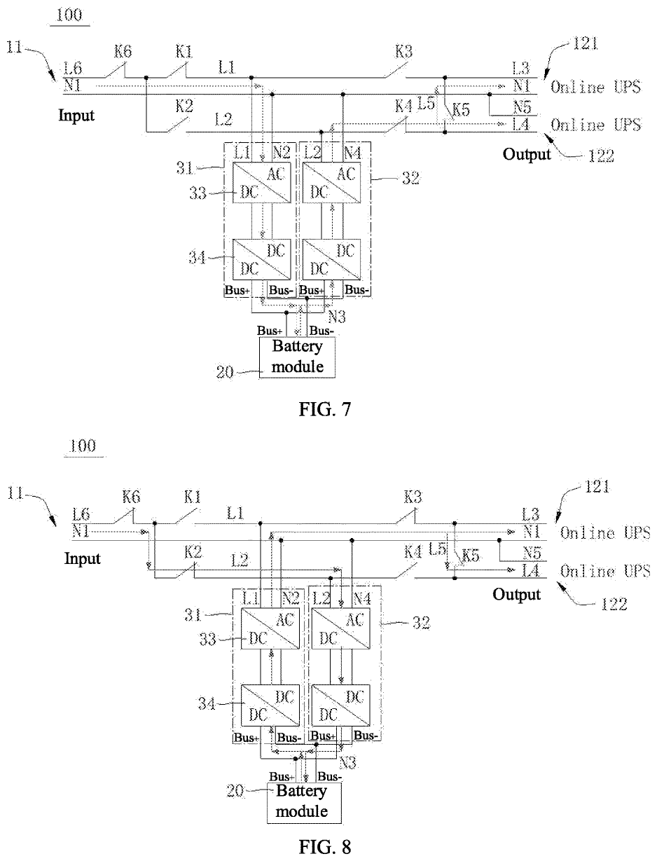

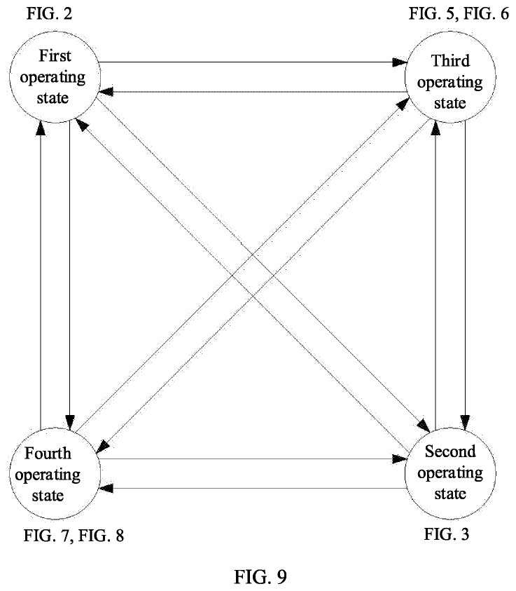

In some embodiments, as illustrated in FIG. 1, FIG. 7, and FIG. 8, when the power supply mode of the first alternating current output terminal 121 and the power supply mode of the second alternating current output terminal 122 are the online power supply mode, the energy storage device 100 operates in a fourth operating mode. When the energy storage device 100 is in the fourth operating mode, the switches and alternating current-direct current conversion modules have two states.

In this case, the third branch L3 is connected to the fourth branch L4 via the fifth branch L5. The fifth branch L5 is provided with the fifth switch K5 to control on and off of the fifth branch L5.

As illustrated in FIG. 7, in a first state: when the energy storage device 100 is in the fourth operating mode, the first switch K1, the fourth switch K4, and the fifth switch K5 are turned on, the second switch K2 and the third switch K3 are turned off, the first alternating current-direct current conversion module 31 operates in the rectifier mode, the second alternating current-direct current conversion module 32 operates in the inverter mode, the first alternating current output terminal 121 and the second alternating current output terminal 122 are powered by the second alternating current-direct current conversion module 32.

In an exemplary embodiment of the present disclosure, when the alternating current power supply 200 supplies power, a current of the alternating current power supply 200 may sequentially flow through the first switch K1, the first branch L1, the first alternating current-direct current conversion module 31, the battery module 20, the second alternating current-direct current conversion module 32, the fourth switch K4, and the fourth branch L4. In this case, the first alternating current-direct current conversion module 31 operates in the rectifier mode, and the second alternating current-direct current conversion module 32 operates in the inverter mode to charge the battery module 20. A current through the fourth branch L4 may be divided into two paths. A first path of current directly flows along the fourth branch L4 to the second alternating current output terminal 122. A second path of current returns to the third branch L3 via the fifth switch K5 and the fifth branch L5, and flows to the first alternating current output terminal 121. The specific current flow direction is shown in FIG. 7. As can be seen, the first alternating current output terminal 121 and the second alternating current output terminal 122 are powered by the second alternating current-direct current conversion module 32. The power supply modes of the two alternating current output terminals are the online power supply mode.

When the alternating current power supply 200 is disconnected, the first alternating current-direct current conversion module 31 operates in the inverter mode or may stop operating, and the second alternating current-direct current conversion module 32 operates in the inverter mode. A current generated by the battery module 20 may sequentially flow through the second alternating current-direct current conversion module 32, the fourth switch K4, and the fourth branch L4. A current through the fourth branch L4 may be divided into two paths. A first path of current directly flows along the fourth branch L4 to the second alternating current output terminal 122. A second path of current returns to the third branch L3 via the fifth switch K5 and the fifth branch L5, and flows to the first alternating current output terminal 121.

As illustrated in FIG. 8, in a second state: when the energy storage device 100 is in the fourth operating mode, the second switch K2, the third switch K3, and the fifth switch K5 are turned on, the first switch K1 and the fourth switch K4 are turned off, the second alternating current-direct current conversion module 32 operates in the rectifier mode, the first alternating current-direct current conversion module 31 operates in the inverter mode, and the first alternating current output terminal 121 and the second alternating current output terminal 122 are powered by the first alternating current-direct current conversion module 31.

In an exemplary embodiment of the present disclosure, when the alternating current power supply 200 supplies power, the current of the alternating current power supply 200 may flow through the second switch K2 and the second branch L2, and then sequentially flow into the second alternating current-direct current conversion module 32, the battery module 20, the first alternating current-direct current conversion module 31, the third switch K3, and the third branch L3. In this case, the second alternating current-direct current conversion module 32 operates in the rectifier mode, and the first alternating current-direct current conversion module 31 operates in the inverter mode to charge the battery module 20. A current through the third branch L3 may be divided into two paths. A first path of current directly flows along the third branch L3 to the first alternating current output terminal 121. A second path of current returns to the fourth branch L4 via the fifth switch K5 and the fifth branch L5, and flows along the fourth branch L4 to the second alternating current output terminal 122. The specific current flow direction is shown in FIG. 8. As can be seen, the first alternating current output terminal 121 and the second alternating current output terminal 122 are powered by the first alternating current-direct current conversion module 31. The power supply modes of the two alternating current output terminals are the online power supply mode.

When the alternating current power supply 200 is disconnected, the first alternating current-direct current conversion module 31 operates in the inverter mode, and the second alternating current-direct current conversion module 32 operates in the inverter mode or may stop operating. A current of the battery module 20 may sequentially flow through the first alternating current-direct current conversion module 31, the third switch K3, and the third branch L3. The current in the third branch L3 may be divided into two paths. A first path of current directly flows along the first branch L1 to the first alternating current output terminal 121. A second path of current returns to the fourth branch L4 via the fifth switch K5 and the fifth branch L5, and flows along the fourth branch L4 to the second alternating current output terminal 122.

Therefore, the above two control manners enable the power supply mode corresponding to the first alternating current output terminal 121 to be the online power supply mode, and the power supply mode corresponding to the second alternating current output terminal 122 to be the online power supply mode.

In some embodiments, as illustrated in FIG. 1 and FIG. 2, the energy storage device 100 further includes a sixth branch L6. The first branch L1 and the second branch L2 are connected to the alternating current input terminal 11 via the sixth branch L6. The sixth branch L6 is provided with a sixth switch K6 to control on and off of the sixth branch L6.

In an exemplary embodiment of the present disclosure, the sixth switch K6 may be configured to control connection and disconnection between the first branch L1 and the alternating current input terminal 11, and control connection and disconnection between the second branch L2 and the alternating current input terminal 11. Therefore, the sixth switch K6 may be configured to control whether the electric energy of the alternating current power supply 200 flows into the energy storage device 100.

Therefore, when the energy storage device 100 needs to operate, regardless of the operating mode of the energy storage device 100, the sixth switch K6 may be controlled to be turned on. When the energy storage device 100 does not need to operate or an emergency occurs, the sixth switch K6 may be controlled to be turned off to directly cut off the path between the energy storage device 100 and the alternating current power supply 200. Therefore, in case of failure, maintenance, or emergency, a connection between the alternating current power supply 200 and the energy storage device 100 may be quickly cut off via the sixth switch K6, to avoid a reverse current or an abnormal voltage of the alternating current power supply 200 from affecting the energy storage system, protecting safety of the device and personnel.

In some embodiments, as illustrated in FIG. 1 and FIG. 2, the energy storage device 100 further includes a controller 40. The controller 40 is configured to determine an adjustment scheme for one or more switches and one or more alternating current-direct current conversion modules based on a current operating mode of the energy storage device 100 and a received control instruction, and control the one or more switches and the one or more alternating current-direct current conversion modules according to the adjustment scheme, to adjust power supply sources of the first alternating current output terminal 121 and the second alternating current output terminal 122. The power supply sources include the one or more alternating current-direct current conversion modules and the alternating current input terminal 11. The one or more alternating current-direct current conversion modules include one or more of the first alternating current-direct current conversion module 31 and the second alternating current-direct current conversion module 32. The one or more switches include one or more of the first switch K1, the second switch K2, the third switch K3, and the fourth switch K4.

In an exemplary embodiment of the present disclosure, states of switches corresponding to different power supply modes may be the same or different, and states of alternating current-direct current conversion modules corresponding to different power supply modes may be the same or different. Therefore, when the controller 40 adjusts the power supply mode of each alternating current output terminal, states of some switches and alternating current-direct current conversion modules may not need to be adjusted. A state of a switch refers to whether the switch is turned on or turned off. A state of an alternating current-direct current conversion module refers to operating in the rectifier mode, operating in the inverter mode, or stopping operating.

After receiving the control instruction, the controller 40 may determine a target state of each switch and a target state of each alternating current-direct current conversion module according to the control instruction, and determine a current state of each switch and a current state of each alternating current-direct current conversion module according to the current operating mode of the energy storage device 100. Then, a switch whose target state is different from the current state is determined as a target switch, and an alternating current-direct current conversion module whose target state is different from the current state is determined as a target alternating current-direct current conversion module. A determined adjustment scheme includes the target switch and the target state corresponding to the target switch, and the target alternating current-direct current conversion module and the target state corresponding to the target alternating current-direct current conversion module.

Then, the controller 40 may control each switch and each alternating current-direct current conversion module according to the adjustment scheme, adjust the state of the target switch to the corresponding target state, and adjust the state of the target alternating current-direct current conversion module to the corresponding target state. For switches and alternating current-direct current conversion modules not included in the adjustment scheme, corresponding states thereof are controlled to remain unchanged, to adjust the power supply sources of the first alternating current output terminal 121 and the second alternating current output terminal 122. The power supply sources include the alternating current-direct current conversion modules and the alternating current input terminal 11, thereby completing adjustment of the power supply modes of the first alternating current output terminal 121 and the second alternating current output terminal 122, and ensuring that the power supply modes of the first alternating current output terminal 121 and the second alternating current output terminal 122 can be accurately adjusted according to the control instruction. In other embodiments of the present disclosure, when adjusting the switches, an on-off sequence of each switch may also be determined to ensure that the power supply mode of the alternating current output terminal can be smoothly adjusted to a target power supply mode.

In some embodiments, as illustrated in FIG. 1 and FIG. 2, when the alternating current output terminal is powered by the alternating current-direct current conversion module, the power supply mode of the alternating current output terminal is the online power supply mode. When the alternating current output terminal is powered by the alternating current input terminal 11, the power supply mode of the alternating current output terminal is the backup power supply mode. The control instruction includes a target operating mode of the energy storage device 100, or includes a target power supply mode of the first alternating current output terminal 121, and a target power supply mode of the second alternating current output terminal 122. The controller 40 is configured to determine the target operating mode of the energy storage device 100 based on the control instruction, and determine the adjustment scheme for each switch and each alternating current-direct current conversion module based on the current operating mode and the target operating mode of the energy storage device 100.

In an exemplary embodiment of the present disclosure, a control application for controlling the energy storage device 100 may be disposed on the terminal. The terminal may send the control instruction to the controller 40 via the control application.

The control application may display the power supply modes of the first alternating current output terminal 121 and the second alternating current output terminal 122 under each operating mode of the energy storage device 100, and thus the user may directly select the target operating mode. After the user selects the target operating mode, the terminal may send a control instruction including the operating mode of the energy storage device 100 to the energy storage device 100. After receiving the control instruction, the controller 40 may determine the target operating mode of the energy storage device 100, and determine the adjustment scheme for the switches and the alternating current-direct current conversion modules according to the current operating mode and the target operating mode of the energy storage device 100, to adjust the operating mode of the energy storage device 100 to the target operating mode of the energy storage device 100.

The control application may also display the power supply modes of the first alternating current output terminal 121 and the second alternating current output terminal 122. The user may directly select target power supply modes of the first alternating current output terminal 121 and the second alternating current output terminal 122, thereby simplifying the operation of the user and allowing selection according to an actual required power supply mode. After the user selects the target power supply modes of the first alternating current output terminal 121 and the second alternating current output terminal 122, the terminal may send a control instruction including the target power supply modes of the first alternating current output terminal 121 and the second alternating current output terminal 122 to the energy storage device 100. After receiving the control instruction, the controller 40 may determine the target operating mode of the energy storage device 100 based on the target power supply modes of the first alternating current output terminal 121 and the second alternating current output terminal 122, and determine the adjustment scheme for the switches and the alternating current-direct current conversion modules based on the current operating mode and the target operating mode of the energy storage device 100, to adjust the operating mode of the energy storage device 100 to the target operating mode of the energy storage device 100.

Therefore, the control instruction may include the target operating mode of the energy storage device 100, or the target power supply modes of the first alternating current output terminal 121 and the second alternating current output terminal 122, which may be set according to the need of the user to improve the user experience. Also, regardless of whether the control instruction includes the target operating mode or the target power supply mode, the controller 40 may accurately adjust each switch and each alternating current-direct current conversion module of the energy storage device 100 based on the control instruction, and adjust the operating mode of the energy storage device 100 to an operating mode matching the control instruction.

In some embodiments, as illustrated in FIG. 1 and FIG. 2, when the target operating mode corresponding to the control instruction includes a plurality of target states of one or more switches, a scheme requiring a minimum number of switches to be adjusted when adjusting the operating mode of the energy storage device 100 to the target operating mode is determined as the adjustment scheme.

In an exemplary embodiment of the present disclosure, a plurality of control schemes of the switches and alternating current-direct current conversion modules corresponding to some operating modes may be provided. For example, comparing FIG. 7 and FIG. 8, when the energy storage device 100 is in the fourth operating mode and the target power supply modes of the first alternating current output terminal 121 and the second alternating current output terminal 122 are the online power supply modes, or comparing FIG. 5 and FIG. 6, when the energy storage device 100 is in the third operating mode and the target power supply modes of the first alternating current output terminal 121 and the second alternating current output terminal 122 are the backup power supply modes, there are two target states of the corresponding switches.

Therefore, when determining the adjustment scheme, if the plurality of target states of the switches corresponding to the target operating mode which corresponds to the control instruction are provided, the controller 40 compares, the target state and the current state of each switch for adjusting the operating mode of the energy storage device 100 to the target operating mode, to determine a number of switches that need to be adjusted when all switches are adjusted from current states to target states. Then, the scheme with the minimum number of switches to be adjusted is determined as the adjustment scheme, and then the switches may be adjusted according to the adjustment scheme. For example, when the target power supply modes of the first alternating current output terminal 121 and the second alternating current output terminal 122 are the online power supply modes, if an adjustment scheme for adjusting the circuit to a circuit shown in FIG. 7 requires adjusting two switches, and an adjustment scheme for adjusting the circuit to a circuit shown in FIG. 8 requires adjusting three switches, in this case the circuit shown in FIG. 7 is adopted, and the adjustment scheme for adjusting the circuit to the circuit shown in FIG. 7 is adopted.

Therefore, on the one hand, adjustment of the power supply mode of the alternating current output terminal to the target power supply mode in the control instruction can be ensured. On the other hand, the number of adjustments of the switches can be reduced, to prolong a service life of the switches and shorten adjustment time of the power supply mode.

Examples of adjustment schemes of the switches under different current power supply modes and different target power supply modes are given as follows.

First, Table 1 is used to summarize a state of each switch in different power supply modes of the first alternating current output terminal 121 and the second alternating current output terminal 122. The L1 output terminal refers to the first alternating current output terminal 121. The L2 output terminal refers to the second alternating current output terminal 122. K represents a switch, and a number following K represents a sequence number of the switch. For example, K6 is the sixth switch K6:

TABLE 1

| | | L1 | L2 | | | | | | | |
|---|---|---|---|---|---|---|---|---|---|---|
| | | output | output | | | | | | | |
| Operating Mode | | terminal | terminal | K1 | K2 | K3 | K4 | K5 | K6 | Diagram |
| First | | Online | Backup | Off | On | On | On | Off | On | FIG. 2 |
| Operating Mode | | | | | | | | | | |
| Second | | Backup | Online | On | Off | On | On | Off | On | FIG. 3 |
| Operating Mode | | | | | | | | | | |
| Third | a | Backup | Backup | On | Off | On | Off | On | On | FIG. 5 |
| Operating Mode | b | | | Off | On | Off | On | On | | FIG. 6 |
| Fourth | a | Online | Online | On | Off | Off | On | On | On | FIG. 7 |
| Operating Mode | b | | | Off | On | On | Off | On | | FIG. 8 |

The AC/DC converter mentioned below refers to the alternating current-direct current converter 33 in the alternating current-direct current conversion module. For example, an AC/DC converter of the first alternating current-direct current conversion module 31 refers to the alternating current-direct current converter 33 in the first alternating current-direct current conversion module 31. An AC/DC converter of the second alternating current-direct current conversion module 32 refers to the alternating current-direct current converter 33 in the second alternating current-direct current conversion module 32.

1. When switching from the second operating mode to the third operating mode, switching from the second operating mode to a third operating mode a is the fastest. Switching from FIG. 3 to FIG. 5 is performed according to the following steps: turning off the fourth switch K4, and stopping the AC/DC converter of the second alternating current-direct current conversion module 32; and turning on the fifth switch K5.

2. When switching from the third operating mode a to the second operating mode, switching from FIG. 5 to FIG. 3 is performed according to the following steps: turning off the fifth switch K5; and turning on the fourth switch K4, with the AC/DC converter of the second alternating current-direct current conversion module 32 operating in the inverter mode to start discharging.

When switching from the third operating mode b to the second operating mode, switching from FIG. 6 to FIG. 3 is performed according to the following steps: turning off the second switch K2 and the fifth switch K5; and turning on the first switch K1 and the third switch K3, with the AC/DC converter of the first alternating current-direct current conversion module 31 operating in the rectifier mode to start charging, and the operating mode of the AC/DC converter of the second alternating current-direct current conversion module 32 being adjusted from the rectifier mode to the inverter mode, i.e., being changed from charging to discharging.

3. When switching from the third operating mode a to the first operating mode, switching from FIG. 5 to FIG. 2 is performed according to the following steps: turning off the first switch K1 and the fifth switch K5; and turning on the second switch K2 and the fourth switch K4, with the AC/DC converter of the second alternating current-direct current conversion module 32 operating in the rectifier mode to start charging, and the operating mode of the AC/DC converter of the first alternating current-direct current conversion module 31 being adjusted from the rectifier mode to the inverter mode, i.e., being changed from charging to discharging.

When switching from the third operating mode b to the first operating mode, switching from FIG. 6 to FIG. 2 is performed according to the following steps: turning off the fifth switch K5; and turning on the third switch K3, with the AC/DC converter of the first alternating current-direct current conversion module 31 operating in the inverter mode to start discharging.

4. When switching from the first operating mode to the third operating mode, switching from FIG. 2 to FIG. 6 is the fastest. The switching steps are as follows: turning off the third switch K3 and stopping the AC/DC converter of the first alternating current-direct current conversion module 31; and turning on the fifth switch K5.

5. When switching from the first operating mode to the fourth operating mode, switching from FIG. 2 to FIG. 8 is the fastest. The switching steps are as follows: turning off the fourth switch K4; and turning on the fifth switch K5.

6. When switching from the fourth operating mode a to the first operating mode, switching from FIG. 7 to FIG. 2 is performed according to the following steps: turning off the fifth switch K5 and stopping discharging of the AC/DC converter of the second alternating current-direct current conversion module 32; turning off the first switch K1, turning on the third switch K3, and stopping charging of the AC/DC converter of the first alternating current-direct current conversion module 31; and turning on the second switch K2, with the AC/DC converter of the first alternating current-direct current conversion module 31 operating in the inverter mode to start discharging, and the AC/DC converter of the second alternating current-direct current conversion module 32 operating in the rectifier mode to start charging.

When switching from the fourth operating mode b to the first operating mode, switching from FIG. 8 to FIG. 2 is performed according to the following steps: turning off the fifth switch K5; and turning on the fourth switch K4.

7. When switching from the fourth operating mode a to the second operating mode, switching from FIG. 7 to FIG. 3 is performed according to the following steps: turning off the fifth switch K5; and turning on the third switch K3.

When switching from the fourth operating mode b to the second operating mode, switching from FIG. 8 to FIG. 3 is performed according to the following steps: turning off the fifth switch K5 and stopping discharging of the AC/DC converter of the first alternating current-direct current conversion module 31; turning off the second switch K2, turning on the fourth switch K4, and stopping charging of the AC/DC converter of the second alternating current-direct current conversion module 32; and turning on the first switch K1, with the AC/DC converter of the first alternating current-direct current conversion module 31 operating in the rectifier mode to start charging, and the AC/DC converter of the second alternating current-direct current conversion module 32 operating in the inverter mode to start discharging.

8. When switching from the second operating mode to the fourth operating mode, switching from FIG. 3 to FIG. 7 is the fastest. The switching steps are as follows: turning off the third switch K3; and turning on the fifth switch K5.

9. When switching from the second operating mode to the first operating mode, switching from FIG. 3 to FIG. 2 is performed according to the following steps: turning off the first switch K1, and stopping charging of the AC/DC converter of the first alternating current-direct current conversion module 31 and discharging of the AC/DC converter of the second alternating current-direct current conversion module 32; and turning on the second switch K2, with the AC/DC converter of the first alternating current-direct current conversion module 31 operating in the inverter mode to start discharging, and the AC/DC converter of the second alternating current-direct current conversion module 32 operating in the rectifier mode to start charging.

10. When switching from the first operating mode to the second operating mode, switching from FIG. 2 to FIG. 3 is performed according to the following steps: turning off the second switch K2, and stopping charging of the AC/DC converter of the second alternating current-direct current conversion module 32 and discharging of the AC/DC converter of the first alternating current-direct current conversion module 31; and turning on the first switch K1, with the AC/DC converter of the second alternating current-direct current conversion module 32 operating in the inverter mode to start discharging, and the AC/DC converter of the first alternating current-direct current conversion module 31 operating in the rectifier mode to start charging.

11. When switching from the third operating mode a to the fourth operating mode, switching from FIG. 5 to FIG. 7 is the fastest. The switching steps are as follows: turning off the third switch K3; and turning on the fourth switch K4, with the AC/DC converter of the second alternating current-direct current conversion module 32 operating in the inverter mode to start discharging.

When switching from the third operating mode b to the fourth operating mode, switching from FIG. 6 to FIG. 8 is the fastest. The switching steps are as follows: turning off the fourth switch K4; and turning on the third switch K3, with the AC/DC converter of the first alternating current-direct current conversion module 31 operating in the inverter mode to start discharging.

12. When switching from the fourth operating mode a to the third operating mode, switching from FIG. 7 to FIG. 5 is the fastest. The switching steps are as follows: turning off the fourth switch K4 and stopping discharging of the AC/DC converter of the second alternating current-direct current conversion module 32; and turning on the third switch K3.

When switching from the fourth operating mode b to the third operating mode, switching from FIG. 8 to FIG. 6 is the fastest. The switching steps are as follows: turning off the third switch K3 and stopping discharging of the AC/DC converter of the first alternating current-direct current conversion module 31; and turning on the fourth switch K4.

As can be seen from the above examples, arbitrary switching may be performed between the first operating mode and the fourth operating mode, as shown in FIG. 9. It can be found that the power supply modes of the first alternating current output terminal 121 and the second alternating current output terminal 122 can be arbitrarily switched to the same mode or different modes. In this way, the power supply modes of the first alternating current output terminal 121 and the second alternating current output terminal 122 can be switched, which can facilitate intelligent selection of the power supply mode by the user.

In some embodiments, as illustrated in FIG. 1 and FIG. 2, after the control instruction is received and operating modes of the first alternating current output terminal 121 and the second alternating current output terminal 122 are adjusted to a target operating mode corresponding to the control instruction, the controller 40 is configured to control operating modes of the alternating current-direct current conversion modules based on the target operating mode and a voltage input state of the alternating current input terminal 11, to supply power to an electrical device 300.

In an exemplary embodiment of the present disclosure, if the power supply mode is the backup power supply mode, the operating mode of the alternating current-direct current conversion module needs to be adjusted according to whether the alternating current power supply 200 supplies power. The voltage input state of the alternating current input terminal 11 is used to indicate whether there is a voltage input to the alternating current input terminal 11, i.e., whether the alternating current power supply 200 supplies power.

After the control instruction is received and the operating modes of the first alternating current output terminal 121 and the second alternating current output terminal 122 are adjusted to the target operating mode corresponding to the control instruction, the controller 40 may control a current operating mode of the alternating current-direct current conversion module based on the target operating mode and the voltage input state of the alternating current input terminal 11. For example, when a target power supply mode of an alternating current output terminal corresponding to the target operating mode is the backup power supply mode, if the voltage input state of the alternating current input terminal 11 indicates that the alternating current power supply 200 supplies power, the controller controls the current operating mode of the alternating current-direct current conversion module corresponding to the alternating current output terminal to be the rectifier mode. If the voltage input state of the alternating current input terminal 11 indicates that the alternating current power supply 200 supplies no power, the controller controls the current operating mode of the alternating current-direct current conversion module corresponding to the alternating current output terminal to be the inverter mode. For example, when the target power supply mode of the alternating current output terminal corresponding to the target operating mode is the online power supply mode, the current operating mode of the alternating current-direct current conversion module corresponding to the alternating current output terminal can always be controlled to be the inverter mode. If a target state of the alternating current-direct current conversion module corresponding to the target operating mode is to stop operating, the corresponding alternating current-direct current conversion module is directly controlled to stop operating.

After the controller 40 controls the operating modes of the alternating current-direct current conversion modules, it can be ensured that the operating mode of each alternating current-direct current conversion module enable the power supply mode corresponding to the alternating current output terminal to be the target power supply mode, and the operating mode of the energy storage device 100 is the target operating mode in the control instruction. Therefore, the energy storage device 100 can accurately supply power to the electrical device 300 in a target power supply mode set by the user.

In some embodiments, as illustrated in FIG. 1 and FIG. 2, the first branch L1, the second branch L2, the third branch L3, the fourth branch L4, the fifth branch L5, and the sixth branch L6 are live wires. The energy storage device 100 further includes a seventh branch N1, an eighth branch N2, a ninth branch N3, a tenth branch N4, and an eleventh branch N5 that are neutral wires. Two ends of the seventh branch N1 are respectively connected to the alternating current input terminal and the first alternating current output terminal 121. The eighth branch N2 is configured to be connected to the seventh branch N1 and the first end of the first alternating current-direct current conversion module 31. The ninth branch N3 is configured to be connected to the second end of the first alternating current-direct current conversion module 31, the second end of the second alternating current-direct current conversion module 32, and the battery module 20. The tenth branch N4 is configured to be connected to the first end of the second alternating current-direct current conversion module 32 and the seventh branch N1. The eleventh branch N5 is configured to be connected to the seventh branch N1 and the second alternating current output terminal 122.

In an exemplary embodiment of the present disclosure, the live wire is a current-carrying conductor in an alternating current (AC) power supply system, responsible for transmitting the current from a power source (such as the alternating current power supply 200 or the UPS) to the electrical device 300. The neutral wire is a return path for the current in the alternating current power supply system. The neutral wire is normally not live (or has only a weak voltage), and is used to form a closed loop, to allow the current to return to the power source.

The first branch L1 to the sixth branch L6 described above are live wires. The energy storage device 100 may further be provided with neutral wires from the seventh branch N1 to the eleventh branch N5. The two ends of the seventh branch N1 are respectively connected to the alternating current input terminal and the first alternating current output terminal 121. The eighth branch N2 is configured to be connected to the seventh branch N1 and the first end of the first alternating current-direct current conversion module 31. The ninth branch N3 is configured to be connected to the second end of the first alternating current-direct current conversion module 31, the second end of the second alternating current-direct current conversion module 32, and the battery module 20. The tenth branch N4 is configured to be connected to the first end of the second alternating current-direct current conversion module 32 and the seventh branch N1. The eleventh branch N5 is configured to be connected to the seventh branch N1 and the second alternating current output terminal 122. It can be found that the seventh branch N1 and the eleventh branch N5 may be configured to be connected to the alternating current input terminal 11, the first alternating current-direct current conversion module 31, the second alternating current-direct current conversion module 32, the battery module 20, the first alternating current output terminal 121, and the second alternating current output terminal 122.

In this way, the energy storage device 100 is provided with corresponding live wires and neutral wires, to ensure that a current loop can be formed among the electrical device 300 connected to the two alternating current output terminals, the alternating current power supply 200, and the battery module 20 through the live wires and the neutral wires, allowing current to flow stably between various components, thereby ensuring that the energy storage device 100 can operate normally.

It should be understood that in the specific embodiments of the present disclosure, when the above embodiments of the present disclosure are applied to specific products or technologies involving data related to an identity or characteristics of the user, user permission or consent is required, and the collection, use, and processing of related data need to comply with relevant laws, regulations, and standards of relevant countries and regions.

Although embodiments of the present disclosure have been illustrated and described, it is conceivable for those skilled in the art that various changes, modifications, replacements, and variations can be made to these embodiments without departing from the principles and spirit of the present disclosure. The scope of the present disclosure shall be defined by the claims as appended and their equivalents.

What is claimed is:

1. An energy storage device, comprising:
an alternating current input terminal configured to be connected to an alternating current power supply;
a first alternating current-direct current conversion module having a first end connected to the alternating current input terminal via a first branch, wherein the first branch is provided with a first switch to control on and off of the first branch;
a second alternating current-direct current conversion module having a first end connected to the alternating current input terminal via a second branch, wherein the second branch is provided with a second switch to control on and off of the second branch;
a battery module electrically connected to a second end of the first alternating current-direct current conversion module and a second end of the second alternating current-direct current conversion module, wherein the battery module is configured to be charged and discharged via the first alternating current-direct current conversion module and the second alternating current-direct current conversion module, and the second end of the first alternating current-direct current conversion module is electrically connected to the second end of the second alternating current-direct current conversion module;
a first alternating current output terminal connected to the first end of the first alternating current-direct current conversion module via a third branch, wherein the third branch is provided with a third switch to control on and off of the third branch, and the first branch is connected to the third branch; and
a second alternating current output terminal connected to the first end of the second alternating current-direct current conversion module via a fourth branch, wherein the fourth branch is provided with a fourth switch to control on and off of the fourth branch, and the second branch is connected to the fourth branch, wherein:
the energy storage device has a first operating mode, wherein when the energy storage device is in the first operating mode, the first switch is turned off, the second switch, the third switch, and the fourth switch are turned on, the first alternating current-direct current conversion module operates in an inverter mode, the second alternating current-direct current conversion module operates in a rectifier mode, the first alternating current output terminal is powered by the first alternating current-direct current conversion module, and the second alternating current output terminal is powered by the alternating current input terminal; and
the energy storage device further has a second operating mode, wherein when the energy storage device is in the second operating mode, the second switch is turned off, the first switch, the third switch, and the fourth switch are turned on, the first alternating current-direct current conversion module operates in the rectifier mode, the second alternating current-direct current conversion module operates in the inverter mode, the first alternating current output terminal is powered by the alternating current input terminal, and the second alternating current output terminal is powered by the second alternating current-direct current conversion module.

2. The energy storage device according to claim 1, wherein the third branch is connected to the fourth branch via a fifth branch, wherein the fifth branch is provided with a fifth switch to control on and off of the fifth branch, and wherein the energy storage device further has a third operating mode, wherein:
when the energy storage device is in the third operating mode, the first switch, the third switch, and the fifth switch are turned on, the second switch and the fourth switch are turned off, the first alternating current-direct current conversion module operates in the rectifier mode, the second alternating current-direct current conversion module stops operating, and the first alternating current output terminal and the second alternating current output terminal are powered by the alternating current input terminal; or
when the energy storage device is in the third operating mode, the second switch, the fourth switch, and the fifth switch are turned on, the first switch and the third switch are turned off, the second alternating current-direct current conversion module operates in the rectifier mode, the first alternating current-direct current conversion module stops operating, and the first alternating current output terminal and the second alternating current output terminal are powered by the alternating current input terminal.

3. The energy storage device according to claim 1, wherein the third branch is connected to the fourth branch via a fifth branch, wherein the fifth branch is provided with a fifth switch to control on and off of the fifth branch, and wherein the energy storage device further has a fourth operating mode, wherein:
when the energy storage device is in the fourth operating mode, the first switch, the fourth switch, and the fifth switch are turned on, the second switch and the third switch are turned off, the first alternating current-direct current conversion module operates in the rectifier mode, the second alternating current-direct current conversion module operates in the inverter mode, and the first alternating current output terminal and the second alternating current output terminal are powered by the second alternating current-direct current conversion module; or
when the energy storage device is in the fourth operating mode, the second switch, the third switch, and the fifth switch are turned on, the first switch and the fourth switch are turned off, the second alternating current-direct current conversion module operates in the rectifier mode, the first alternating current-direct current conversion module operates in the inverter mode, and the first alternating current output terminal and the second alternating current output terminal are powered by the first alternating current-direct current conversion module.

4. The energy storage device according to claim 1, further comprising a sixth branch, wherein the first branch and the second branch are connected to the alternating current input terminal via the sixth branch, the sixth branch being provided with a sixth switch to control on and off of the sixth branch.

5. The energy storage device according to claim 2, further comprises a sixth branch, wherein the first branch and the second branch are connected to the alternating current input terminal via the sixth branch, the sixth branch being provided with a sixth switch to control on and off of the sixth branch.

6. The energy storage device according to claim 3, further comprising a sixth branch, wherein the first branch and the second branch are connected to the alternating current input terminal via the sixth branch, the sixth branch being provided with a sixth switch to control on and off of the sixth branch.

7. The energy storage device according to claim 1, further comprising a controller configured to determine an adjustment scheme for one or more switches and one or more alternating current-direct current conversion modules based on a current operating mode of the energy storage device and a received control instruction, and configured to control the one or more switches and the one or more alternating current-direct current conversion modules according to the adjustment scheme, to adjust power supply sources of the first alternating current output terminal and the second alternating current output terminal, wherein the power supply sources comprise the one or more alternating current-direct current conversion modules and the alternating current input terminal, wherein the one or more alternating current-direct current conversion modules comprise one or more of the first alternating current-direct current conversion module and the second alternating current-direct current conversion module, and wherein the one or more switches at least comprise one or more of the first switch, the second switch, the third switch, and the fourth switch.

8. The energy storage device according to claim 2, further comprising a controller configured to determine an adjustment scheme for one or more switches and one or more alternating current-direct current conversion modules based on a current operating mode of the energy storage device and a received control instruction, and configured to control the one or more switches and the one or more alternating current-direct current conversion modules according to the adjustment scheme, to adjust power supply sources of the first alternating current output terminal and the second alternating current output terminal, wherein the power supply sources comprise the one or more alternating current-direct current conversion modules and the alternating current input terminal, wherein the one or more alternating current-direct current conversion modules comprise one or more of the first alternating current-direct current conversion module and the second alternating current-direct current conversion module, and wherein the one or more switches at least comprise one or more of the first switch, the second switch, the third switch, and the fourth switch.

9. The energy storage device according to claim 3, further comprising a controller configured to determine an adjustment scheme for one or more switches and one or more alternating current-direct current conversion modules based on a current operating mode of the energy storage device and a received control instruction, and configured to control the one or more switches and the one or more alternating current-direct current conversion modules according to the adjustment scheme, to adjust power supply sources of the first alternating current output terminal and the second alternating current output terminal, wherein the power supply sources comprise the one or more alternating current-direct current conversion modules and the alternating current input terminal, wherein the one or more alternating current-direct current conversion modules comprise one or more of the first alternating current-direct current conversion module and the second alternating current-direct current conversion module, and wherein the one or more switches at least comprise one or more of the first switch, the second switch, the third switch, and the fourth switch.

10. The energy storage device according to claim 4, further comprising a controller configured to determine an adjustment scheme for one or more switches and one or more alternating current-direct current conversion modules based on a current operating mode of the energy storage device and a received control instruction, and configured to control the one or more switches and the one or more alternating current-direct current conversion modules according to the adjustment scheme, to adjust power supply sources of the first alternating current output terminal and the second alternating current output terminal, wherein the power supply sources comprise the one or more alternating current-direct current conversion modules and the alternating current input terminal, wherein the one or more alternating current-direct current conversion modules comprise one or more of the first alternating current-direct current conversion module and the second alternating current-direct current conversion module, and wherein the one or more switches at least comprise one or more of the first switch, the second switch, the third switch, and the fourth switch.

11. The energy storage device according to claim 5, further comprising a controller configured to determine an adjustment scheme for one or more switches and one or more alternating current-direct current conversion modules based on a current operating mode of the energy storage device and a received control instruction, and configured to control the one or more switches and the one or more alternating current-direct current conversion modules according to the adjustment scheme, to adjust power supply sources of the first alternating current output terminal and the second alternating current output terminal, wherein the power supply sources comprise the one or more alternating current-direct current conversion modules and the alternating current input terminal, wherein the one or more alternating current-direct current conversion modules comprise one or more of the first alternating current-direct current conversion module and the second alternating current-direct current conversion module, and wherein the one or more switches at least comprise one or more of the first switch, the second switch, the third switch, and the fourth switch.

12. The energy storage device according to claim 6, further comprising a controller configured to determine an adjustment scheme for one or more switches and one or more alternating current-direct current conversion modules based on a current operating mode of the energy storage device and a received control instruction, and configured to control the one or more switches and the one or more alternating current-direct current conversion modules according to the adjustment scheme, to adjust power supply sources of the first alternating current output terminal and the second alternating current output terminal, wherein the power supply sources comprise the one or more alternating current-direct current conversion modules and the alternating current input terminal, wherein the one or more alternating current-direct current conversion modules comprise one or more of the first alternating current-direct current conversion module and the second alternating current-direct current conversion module, and wherein the one or more switches at least comprise one or more of the first switch, the second switch, the third switch, and the fourth switch.

13. The energy storage device according to claim 7, wherein when a target operating mode corresponding to the control instruction comprises a plurality of target states of the one or more switches, the adjustment scheme is a scheme requiring a minimum number of switches to be adjusted to switch an operating mode of the energy storage device to the target operating mode.

14. The energy storage device according to claim 7, wherein:
when an alternating current output terminal is powered by an alternating current-direct current conversion module, a power supply mode of the alternating current output terminal is an online power supply mode, and when the alternating current output terminal is powered by the alternating current input terminal, the power supply mode of the alternating current input terminal is a backup power supply mode; and
the control instruction comprises a target operating mode of the energy storage device, or comprises a target power supply mode of the first alternating current output terminal and a target power supply mode of the second alternating current output terminal, wherein the controller is configured to determine the target operating mode of the energy storage device based on the control instruction, and determine the adjustment scheme for the one or more switches and the one or more alternating current-direct current conversion modules based on the current operating mode and the target operating mode of the energy storage device.

15. The energy storage device according to claim 7, wherein the controller is configured to, after the control instruction is received and operating modes of the first alternating current output terminal and the second alternating current output terminal are adjusted to a target operating mode corresponding to the control instruction, control operating modes of the one or more alternating current-direct current conversion modules based on the target operating mode and a voltage input state of the alternating current input terminal, to supply power to an electrical device.

16. The energy storage device according to claim 1, wherein each alternating current-direct current conversion module comprises an alternating current-direct current converter and a direct current-direct current converter, wherein:
the direct current-direct current converter is disposed between the alternating current-direct current converter and the battery module;
an operating mode of the alternating current-direct current conversion module is defined as an operating mode of the alternating current-direct current converter; and
the alternating current-direct current conversion module comprises the first alternating current-direct current conversion module and the second alternating current-direct current conversion module.

17. The energy storage device according to claim 4, wherein
the third branch is connected to the fourth branch via a fifth branch, wherein the fifth branch is provided with a fifth switch to control on and off of the fifth branch, and the first branch and the second branch are connected to the alternating current input terminal via a sixth branch, wherein:
the first branch, the second branch, the third branch, the fourth branch, the fifth branch, and the sixth branch are live wires;
the energy storage device further comprises a seventh branch, an eighth branch, a ninth branch, a tenth branch, and an eleventh branch that are neutral wires;
two ends of the seventh branch are respectively connected to the alternating current input terminal and the first alternating current output terminal;
the eighth branch is configured to be connected to the seventh branch and the first end of the first alternating current-direct current conversion module;
the ninth branch is configured to be connected to the second end of the first alternating current-direct current conversion module, the second end of the second alternating current-direct current conversion module, and the battery module;
the tenth branch is configured to be connected to the first end of the second alternating current-direct current conversion module and the seventh branch; and
the eleventh branch is configured to be connected to the seventh branch and the second alternating current output terminal.
